(19) United States
(12) Patent Application Publication
(10) Pub. No.: US 2024/0304123 A1
(43) Pub. Date: Sep. 12, 2024

(54) Full-Mast to Half-Mast Convertible Flagpole Device

(71) Applicant: Charles West, Hilliard, OH (US)

(72) Inventor: Charles West, Hilliard, OH (US)

(21) Appl. No.: 18/480,159

(22) Filed: Oct. 3, 2023

Related U.S. Application Data
(60) Provisional application No. 63/450,801, filed on Mar. 8, 2023.

(51) Int. Cl. G09F 17/00; E04H 12/22; E04H 12/32; F16B 7/18

(52) U.S. Cl. CPC G09F 17/00; E04H 12/22; E04H 12/32; F16B 7/182

(57) ABSTRACT

A wall-mounted flagpole extension device is provided. The device is comprised of a base plate comprised of at least a first receiving point and a primary and secondary flagpole. The flag can be attached to the primary flagpole to be flown at a full-mast position. When a user desires to display the flag at a half-mast position, a user can attach the secondary flagpole to the end of the primary flagpole to give the appearance that the flag is now being flown at half-mast.

### CROSS-REFERENCE TO RELATED APPLICATION

The present application claims priority to, and the benefit of, U.S. Provisional Application No. 63/450,801, which was filed on Mar. 8, 2023, and is incorporated herein by reference in its entirety.

### FIELD OF THE INVENTION

The present invention relates generally to the field of flags. More specifically, the present invention relates to a full-mast to half-mast convertible flagpole device that allows a user to fly a flag at a plurality of angles. In addition, the device allows a user to easily fly a flag at full-mast or half-mast in an easily interchangeable manner. Accordingly, the present disclosure makes specific reference thereto. Nonetheless, it is to be appreciated that aspects of the present invention are also equally applicable to other like applications, devices, and methods of manufacture.

### BACKGROUND

Many scenarios may require flags to be flown at half-mast. However, individuals may have trouble adjusting their residential, home-mounted flags to a half-mast state. More specifically, said wall-mounted residential flags typically cannot accommodate being flown at half-mast. Furthermore, the flag must still be adjusted to full-mast after the half-mast period has ended. In addition, wall-mounted flags only provide a user with one angle to display the flag, which may be undesirable for some mounting scenarios.

Therefore, there exists a long-felt need in the art for an improved flag mount. More specifically, there exists a long-felt need in the art for a full-mast to half-mast convertible flagpole device that allows a flag to be flown at half-mast. In addition, there exists a long-felt need in the art for a full-mast to half-mast convertible flagpole device that allows a flag to be flown at half-mast and then allows the flag to easily be returned to full-mast. There also exists a long-felt need in the art for a full-mast to half-mast convertible flagpole device that allows a flag to be flown at a plurality of angles while at half-mast.

The subject matter disclosed and claimed herein, in one embodiment thereof, comprises a full-mast to half-mast convertible flagpole device. The device is comprised of a base plate comprised of at least a first receiving point and a primary and secondary flagpole. The flag can be attached to the primary flagpole to be flown at a full-mast position. When a user desires to display the flag at a half-mast position, a user can attach the secondary flagpole to the end of the primary flagpole to give the appearance that the flag is now being flown at half-mast.

In this manner, the full-mast to half-mast convertible flagpole device of the present invention accomplishes all the foregoing objectives and provides an improved flag mount that allows a flag to be flown at half-mast. In addition, the device also allows the flag to easily be returned to full-mast. Furthermore, the device allows a flag to be flown at a plurality of angles while at half-mast.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a full-mast to half-mast convertible flagpole device. The device is designed to allow a user to display at least one flag in a position resembling half-mast or full-mast, and at a plurality of angles. The base plate of the device contacts a wall when the device is mounted. The front surface of the base plate is comprised of at least one receiving area. The receiving area is preferably cylindrical in shape to receive a primary flagpole via at least one opening of the receiving area. In one embodiment, the front surface may be comprised of a second receiving area with an opening and a third receiving area comprised of an opening. The openings preferably form angles less than 180 degrees with the front surface to allow the pole (and attached flag) to be erected at a plurality of angles. Each receiving area may be comprised of at least one set screw or another similar fastener of the like to secure the primary pole.

The primary pole is comprised of at least one flag fastener. The fastener allows at least one flag to be attached to the pole in a removable fashion. The primary pole is comprised of at least one fastener at the end of the pole that is not received by the receiving area. The device is also comprised of at least one secondary pole with at least one fastener. The fasteners of the poles are preferably reciprocating fasteners such as, but not limited to, male and female threaded fasteners. Once the secondary pole is attached to the primary pole, the device has the appearance of the flag being flown at half-mast. When a user desires for the device not to have the appearance of a flag being flown at half-mast, a user can simply remove the secondary pole to give the appearance of the flag flying at full-mast.

The present invention is also comprised of a method of using the device. First, a device is provided comprised of a base plate with at least one first receiving area, a primary pole, a secondary pole, and at least one flag comprised of at least one flag fastener. Then, a user secures the base plate to a wall surface. Next, a user places the primary pole into the receiving area. Then, the user can secure the topper to the fastener of the secondary pole using a fastener of the topper.

The present invention is also comprised of a second method of using the device. First, a device is provided comprised of a base plate with at least one first receiving area, a primary pole, a secondary pole, and at least one flag comprised of at least one flag fastener. Then, a user secures the base plate to a wall surface. Next, a user places the primary pole into the receiving area. Then, the user can secure the secondary pole to the primary pole via the fasteners of each pole. Then, the user can secure the topper to the fastener of the secondary pole using a fastener of the topper.

Accordingly, the full-mast to half-mast convertible flagpole device of the present invention is particularly advantageous as it provides an improved flag mount that allows a flag to be flown at half-mast. In addition, the device allows a flag to be flown at half-mast and then allows the flag to easily be returned to full-mast. Further, the device allows a flag to be flown at a plurality of angles while at half-mast. In this manner, the full-mast to half-mast convertible flagpole device overcomes the limitations of existing wall-mounted flag mounts known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an enhanced perspective view of one potential embodiment of a full-mast to half-mast convertible flagpole device of the present invention in accordance with the disclosed architecture;

FIG. 2 illustrates an enhanced perspective view of one potential embodiment of a full-mast to half-mast convertible flagpole device of the present invention in accordance with the disclosed architecture;

FIG. 3 illustrates a perspective view of one potential embodiment of a full-mast to half-mast convertible flagpole device of the present invention while in a full-mast configuration in accordance with the disclosed architecture;

FIG. 4 illustrates an enhanced perspective view of one potential embodiment of a full-mast to half-mast convertible flagpole device of the present invention while in a full-mast configuration in accordance with the disclosed architecture;

FIG. 5 illustrates an exploded perspective view of one potential embodiment of a full-mast to half-mast convertible flagpole device of the present invention while in a half-mast configuration in accordance with the disclosed architecture;

FIG. 6 illustrates a perspective view of one potential embodiment of a full-mast to half-mast convertible flagpole device of the present invention while in a half-mast configuration in accordance with the disclosed architecture;

FIG. 7 illustrates a flowchart of a method of using one potential embodiment of a full-mast to half-mast convertible flagpole device of the present invention in accordance with the disclosed architecture; and

FIG. 8 illustrates a flowchart of a method of using one potential embodiment of a full-mast to half-mast convertible flagpole device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved flag mount. More specifically, there exists a long-felt need in the art for a full-mast to half-mast convertible flagpole device that allows a flag to be flown at half-mast. In addition, there exists a long-felt need in the art for a full-mast to half-mast convertible flagpole device that allows a flag to be flown at half-mast and then allows the flag to easily be returned to full-mast. There also exists a long-felt need in the art for a full-mast to half-mast convertible flagpole device that allows a flag to be flown at a plurality of angles while at half-mast.

The present invention, in one exemplary embodiment, is comprised of a full-mast to half-mast convertible flagpole device designed to allow a user to display at least one flag in a position resembling half-mast or full-mast, and at a plurality of angles. A base plate of the device contacts a wall when the device is mounted, wherein the front surface of the base plate is comprised of at least one receiving area. The receiving area is preferably cylindrical in shape to receive a primary flagpole via at least one opening of the receiving area. In one embodiment, the front surface may be comprised of a second receiving area with an opening and a third receiving area comprised of an opening. The openings preferably form angles less than 180 degrees with the front surface to allow the pole (and attached flag) to be erected at a plurality of angles. Each receiving area may be comprised of at least one set screw or other similar fastener of the like to secure the primary pole.

The primary pole is comprised of at least one flag fastener that allows at least one flag to be attached to the pole in a removable fashion. The primary pole is comprised of at least one fastener at the end of the pole that is not received by the receiving area. The device is also comprised of at least one secondary pole with at least one fastener. The fasteners of the poles are preferably reciprocating fasteners such as, but not limited to, male and female threaded fasteners. Once the secondary pole is attached to the primary pole, the device has the appearance of the flag being flown at half-mast. When a user desires for the device not to have the appearance of a flag being flown at half-mast, a user can simply remove the secondary pole to give the appearance of the flag flying at full-mast.

The present invention is also comprised of a method of using the device. First, a device is provided comprised of a base plate with at least one first receiving area, a primary pole, a secondary pole, and at least one flag comprised of at least one flag fastener. Then, a user secures the base plate to a wall surface. Next, a user places the primary pole into the receiving area. Then, the user can secure the topper to the fastener of the secondary pole using a fastener of the topper.

The present invention is also comprised of a second method of using the device. First, a device is provided comprised of a base plate with at least one first receiving area, a primary pole, a secondary pole, and at least one flag comprised of at least one flag fastener. Then, a user secures the base plate to a wall surface. Next, a user places the primary pole into the receiving area. Then, the user can secure the secondary pole to the primary pole via the fasteners of each pole. Then, the user can secure the topper to the fastener of the secondary pole using a fastener of the topper.

Accordingly, the full-mast to half-mast convertible flagpole device of the present invention is particularly advantageous as it provides an improved flag mount that allows a flag to be flown at half-mast. In addition, the device allows a flag to be flown at half-mast and then allows the flag to easily be returned to full-mast. Further, the device allows a flag to be flown at a plurality of angles while at half-mast. In this manner, the full-mast to half-mast convertible flagpole device overcomes the limitations of existing wall-mounted flag mounts known in the art.

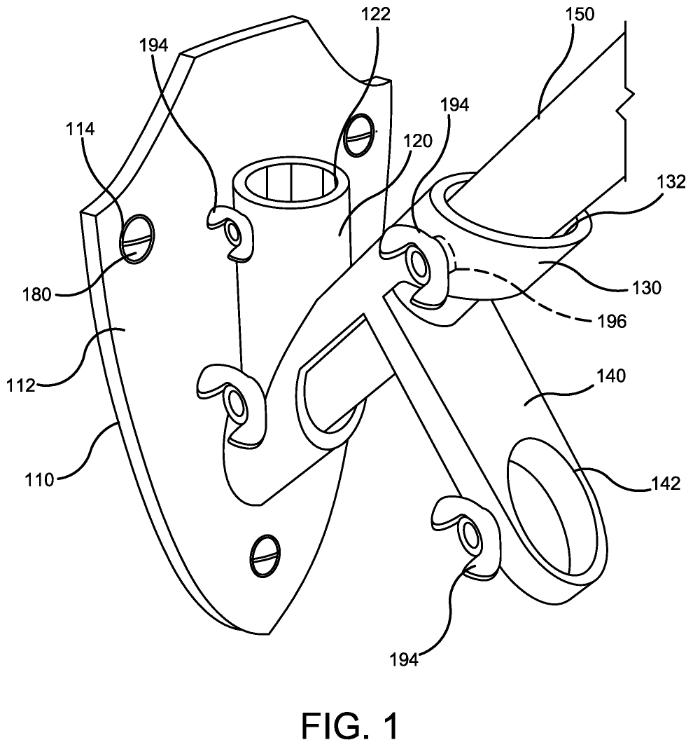

Referring initially to the drawings, FIG. 1 illustrates an enhanced perspective view of one potential embodiment of a full-mast to half-mast convertible flagpole device 100 of the present invention in accordance with the disclosed architecture. The device 100 is designed to allow a user to display at least one flag 192 in a position resembling half-mast or full-mast. The device 100 also allows a user to position the flag 192 at a plurality of angles. The device 100 and all components are preferably made of some combination of metal, UV-resistant plastic, wood, or other material.

The base plate 110 of the device 100 contacts a wall 10 when the device 100 is mounted. The base plate 110 may be of any size and shape known in the art in different embodiments. The base plate 110 may be comprised of at least one opening 114. The opening 114 allows at least one fastener 180 such as, but not limited to, a screw to be screwed through the base plate 110 to secure the base plate 110 to a wall 10.

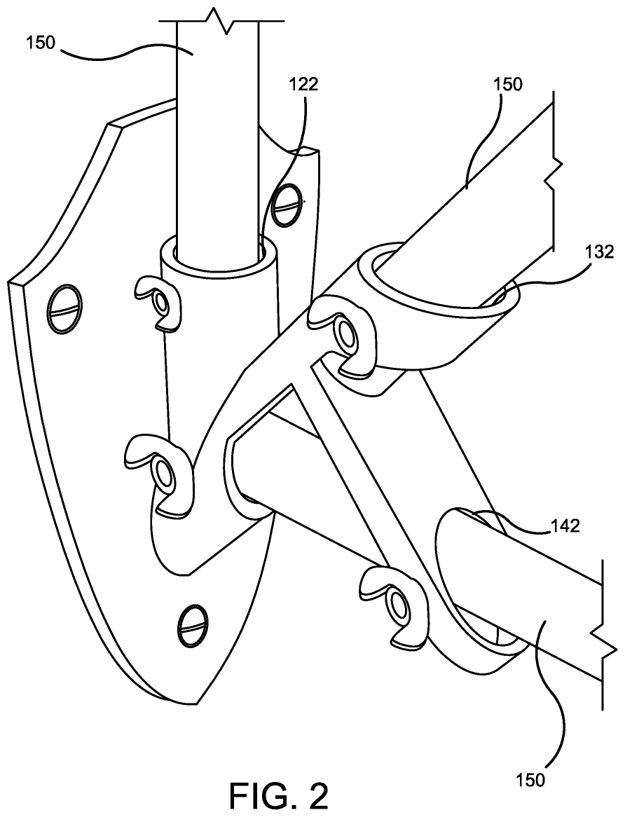

The front surface 112 of the base plate 110 is comprised of at least one receiving area 120. The receiving area 120 is preferably cylindrical in shape to receive a primary flagpole 150 via at least one opening 122 of the receiving area 120. In one embodiment, the front surface 112 may be comprised of a second receiving area 130 with an opening 132 and a third receiving area 140 comprised of an opening 142. The openings 120,130,140 preferably form angles less than 180 degrees with the front surface 112 to allow the pole 150 (and attached flag 192) to be erected at a plurality of angles, as seen in FIG. 1 and FIG. 2. Each area 120,130,140 may be attached to any other area 120,130,140 in any position orientation, arrangement, etc.

Each receiving area 120,130,140 may be comprised of at least one set screw 194 or other similar fastener of the like. The set screw 194 is preferably threaded and can be screwed into a threaded opening 196 of the receiving area 120,130,140 after the primary pole 150 has been inserted to secure the pole 150 into the area 120,130,140 via the screw 194. The secondary pole 160 may also be stored in any receiving area 120,130,140 when not in use in the same manner.

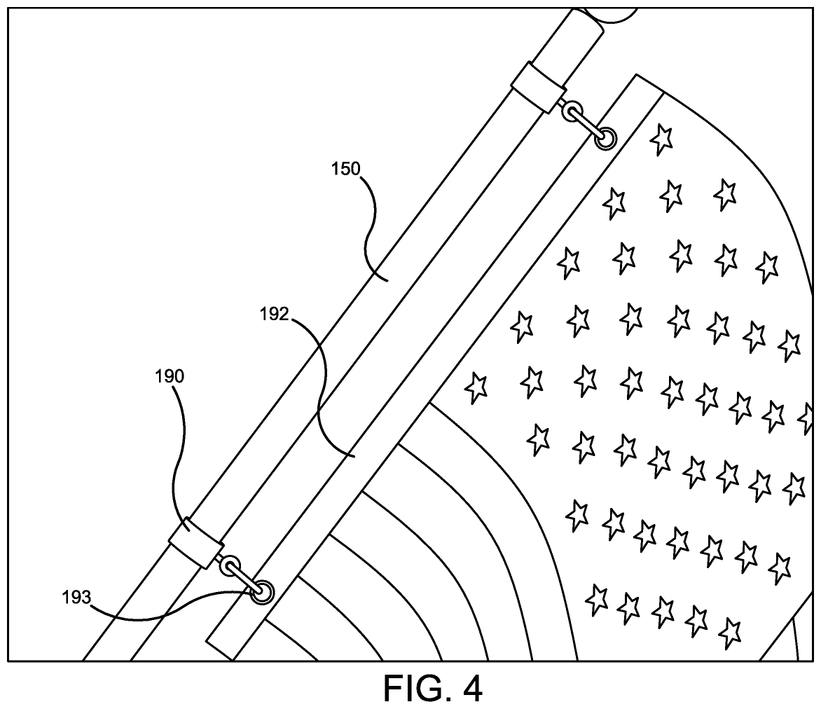

The primary pole 150 is comprised of at least one flag fastener 190. The fastener 190 allows at least one flag 192 to be attached to the pole 150 in a removable fashion, as seen in FIG. 4. The fastener 190 may be any type of fastener such as, but not limited to, a clip, a clamp, a carabiner, etc., that can be inserted into the eyelet 193 of a flag 192.

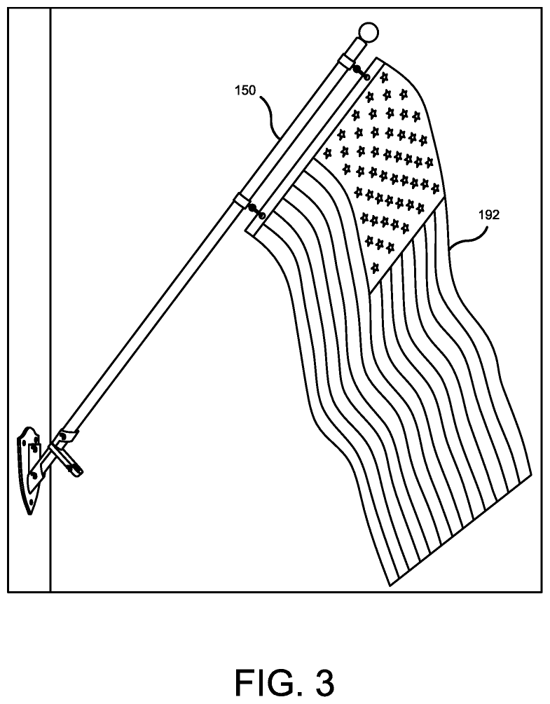

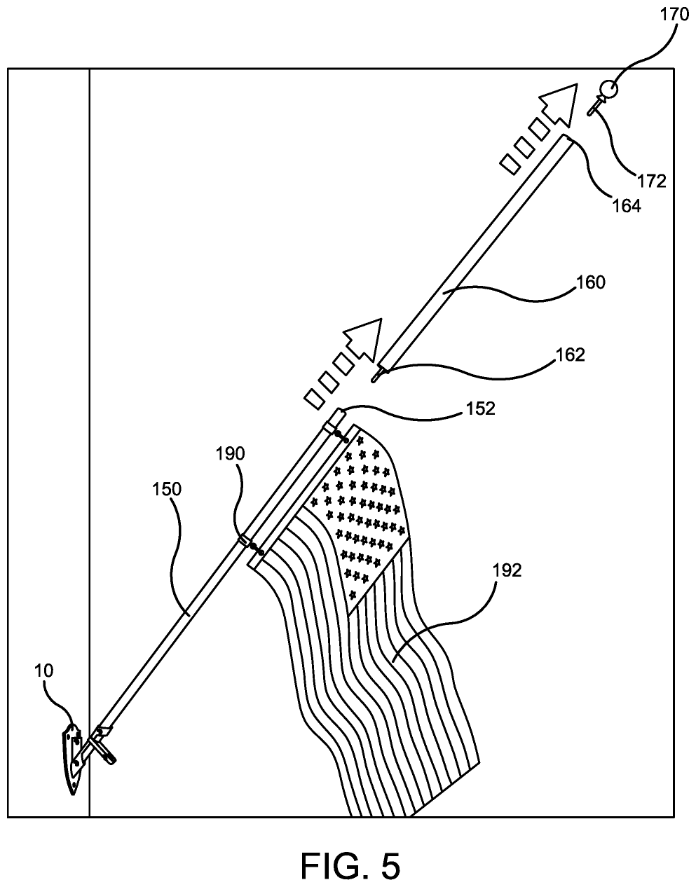

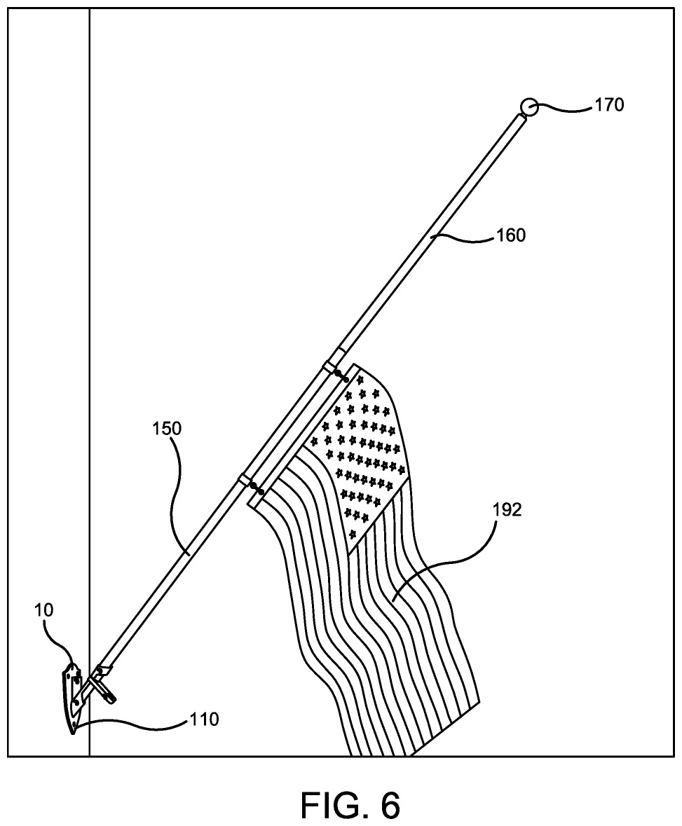

The primary pole 150 is comprised of at least one fastener 152 at the end of the pole 150 that is not received by the receiving area 120,130,140. The device 100 is also comprised of at least one secondary pole 160 with at least one fastener 162. The fasteners 152,162 of the poles 150,160 are preferably reciprocating fasteners such as, but not limited to, male and female threaded fasteners, as seen in FIG. 5. Once the secondary pole 160 is attached to the primary pole 150, the device 100 has the appearance of the flag 192 being flown at half-mast, as seen in FIG. 6. When a user desires for the device 100 not have the appearance of a flag 192 being flown at half-mast, a user can simply remove the secondary pole 160 to give the appearance of the flag 192 flying at full-mast, as seen in FIG. 3.

The secondary pole 160 and/or primary pole 150 may also receive at least one topper 170. The topper 170 may resemble any object, emblem, symbol, shape, character, animal, etc. The topper 170 is comprised of at least one fastener 172 that allows the topper 170 to be attached to the secondary pole 160 via at least one reciprocating secondary fastener 164. The fasteners 164,172 are preferably male and female threaded fasteners. The fastener 172 of the topper 170 may also allow the topper 170 to attach to the fastener 152 of the primary pole 150 when the device is used at full-mast.

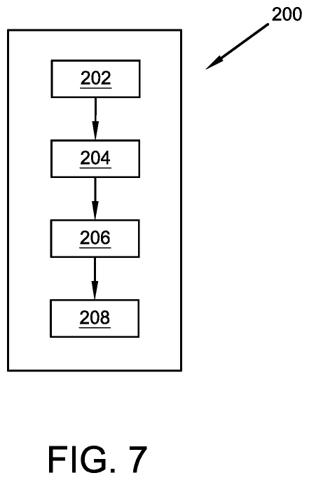

The present invention is also comprised of a method of using 200 the device 100, as seen in FIG. 7. First, a device 100 is provided comprised of a base plate 110 with at least one first receiving area 120, a primary pole 150, a secondary pole 160, and at least one flag 192 comprised of at least one flag fastener 190 [Step 202]. Then, a user secures the base plate 110 to a wall surface 10 [Step 204]. Then, a user places the primary pole 150 into the receiving area 120 [Step 206]. Then, the user can secure the topper 170 to the fastener 164 of the secondary pole 160 using a fastener 172 of the topper 170 [Step 208].

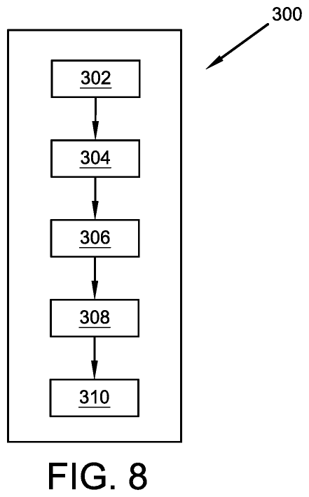

The present invention is also comprised of a second method of using 300 the device 100, as seen in FIG. 8. First, a device 100 is provided comprised of a base plate 110 with at least one first receiving area 120, a primary pole 150, a secondary pole 160, and at least one flag 192 comprised of at least one flag fastener 190 [Step 302]. Then, a user secures the base plate 110 to a wall surface 10 [Step 304]. Then, a user places the primary pole 150 into the receiving area 120 [Step 306]. Next, the user can secure the secondary pole 160 to the primary pole 150 via the fasteners 152,162 of each pole 150,160 [Step 308]. Then, the user can secure the topper 170 to the fastener 164 of the secondary pole 160 using a fastener 172 of the topper 170 [Step 310].

Certain terms are used throughout the following description and claim to refer to particular features or components. As one skilled in the art will appreciate, different persons, may refer to the same feature or component by different names. This document does not intend to distinguish between components or features that differ in name but not structure or function. As used herein “full-mast to half-mast convertible flagpole device” and “device” are interchangeable and refer to the full-mast to half-mast convertible flagpole device 100 of the present invention.

Notwithstanding the foregoing, the full-mast to half-mast convertible flagpole device 100 of the present invention and its various components can be of any suitable size and configuration as is known in the art without affecting the overall concept of the invention, provided that they accomplish the above-stated objectives. One of ordinary skill in the art will appreciate the size, configuration, and material of the full-mast to half-mast convertible flagpole device 100 as shown in the FIGS. are for illustrative purposes only, and that many other sizes and shapes of the full-mast to half-mast convertible flagpole device 100 are well within the scope of the present disclosure. Although the dimensions of the full-mast to half-mast convertible flagpole device 100 are important design parameters for user convenience, the full-mast to-half-mast convertible flagpole device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A full-mast to half-mast convertible flagpole device comprising:
a base plate comprised of a receiving area;
a primary pole comprised of a first fastener;
a secondary pole comprised of a second fastener;
a flag; and
a flag fastener.

2. The full-mast to half-mast convertible flagpole device of claim 1, wherein the receiving area is comprised of a threaded set screw.

3. The full-mast to half-mast convertible flagpole device of claim 1, wherein the first fastener is comprised of a threaded fastener.

4. The full-mast to half-mast convertible flagpole device of claim 1, wherein the second fastener is comprised of a threaded fastener.

5. The full-mast to half-mast convertible flagpole device of claim 1, wherein the flag fastener is comprised of a clip or a clamp.

6. The full-mast to half-mast convertible flagpole device of claim 1, wherein the receiving area is comprised of a threaded opening.

7. A full-mast to half-mast convertible flagpole device comprising:
a base plate comprised of a first receiving area and a second receiving area;
a primary pole comprised of a first fastener;
a secondary pole comprised of a second fastener;
a flag; and
a flag fastener.

8. The full-mast to half-mast convertible flagpole device of claim 7 further comprised of a topper.

9. The full-mast to half-mast convertible flagpole device of claim 8, wherein the topper is comprised of a third fastener.

10. The full-mast to half-mast convertible flagpole device of claim 9, wherein the third fastener is comprised of a threaded fastener.

11. The full-mast to half-mast convertible flagpole device of claim 7, wherein the secondary pole is comprised of a fourth fastener.

12. The full-mast to half-mast convertible flagpole device of claim 11, wherein the fourth fastener is comprised of a threaded fastener.

13. The full-mast to half-mast convertible flagpole device of claim 7, wherein the first fastener is comprised of a threaded fastener.

14. The full-mast to half-mast convertible flagpole device of claim 7, wherein the second fastener is comprised of a threaded fastener.

15. The full-mast to half-mast convertible flagpole device of claim 7, wherein the first receiving area forms an angle less than 180 degrees with a front surface of the base plate.

16. The full-mast to half-mast convertible flagpole device of claim 7, wherein the second receiving area forms an angle less than 180 degrees with a front surface of the base plate.

17. The full-mast to half-mast convertible flagpole device of claim 7, wherein the base plate is comprised of an opening.

18. The full-mast to half-mast convertible flagpole device of claim 7, wherein the first receiving area is positioned on a front surface of the base plate.

19. The full-mast to half-mast convertible flagpole device of claim 7, wherein the second receiving area is positioned on a front surface of the base plate.

20. A method of using a full-mast to half-mast convertible flagpole device, the method comprising the following steps:
providing a full-mast to half-mast convertible flagpole device comprised of a base plate with a first receiving area, a primary pole, a secondary pole, a flag, and a flag fastener;
securing the base plate to a surface;
placing and securing the primary pole into the first receiving area; and
securing the secondary pole to the primary pole.
